(19) United States
(12) Patent Application Publication
(10) Pub. No.: US 2024/0107957 A1
(43) Pub. Date: Apr. 4, 2024

(54) SYSTEM AND METHOD FOR COMMUNICATING TO MULTIPLE CONTROLLERS ON A MECHANIZED IRRIGATION MACHINE

(71) Applicant: Lindsay Corporation, Omaha, NE (US)

(72) Inventors: Mark William Miller, Elkhorn, NE (US); Luke Joseph Barker, Omaha, NE (US)

(21) Appl. No.: 17/937,486

(22) Filed: Oct. 3, 2022

(51) Int. Cl. A01G 25/16; A01G 25/09

(52) U.S. Cl. CPC A01G 25/16; A01G 25/092

(57) ABSTRACT

A smart irrigation system including a mechanized irrigation machine having a main machine controller, a plurality of distributed controllers, and a communications network. The distributed controllers may be located at a plurality of spaced apart locations on the mechanized irrigation machine. The communications network may communicably couple the plurality of distributed controllers, the main machine controller, and local or remote cloud storage. Furthermore, the main machine controller and the plurality of distributed controllers may retrieve or store information from the local or remote cloud storage for maintenance, firmware updates, or troubleshooting of the mechanized irrigation machine. The distributed controllers may perform the following functions: individual tower motor control, span joint control, corner arm control, GPS guidance or positioning of one or more actuatable features of the smart irrigation system, and/or valve control of individual sprinklers for variable rate irrigation.

### BACKGROUND

Embodiments of the present invention relate to a system and method for communicating to multiple controllers on a mechanized irrigation machine for irrigating agricultural fields.

Irrigation systems are frequently used to deposit water and/or pesticides throughout a field of crops. Center pivot irrigation systems move in a circle or semi-circle about a central pivot while lateral irrigation systems are configured to move along a generally straight line across a square or rectangular-shaped field. Some irrigation systems additionally or alternatively include corner spans that can rotate about a far end point on a row of spans of a central pivot irrigation system or a lateral irrigation system.

Prior art mechanize irrigation machines are limited to basic electrical and electromechanical devices that do not communicate more than basic discrete information from outer controllers to a main controller (e.g., on/of commands for end guns, direction of travel, percent speed). This presents limits in what is communicated, when it is communicated, and often requires a user to determine how to respond to these discrete bits of information received by a control system.

Accordingly, there is a need for a mechanized irrigation system that overcomes the limitations of the prior art.

### SUMMARY

Embodiments of the present invention solve the above-described problems by providing a smart irrigation system that more effectively communicates among disparate distributed controllers. Specifically, an embodiment of the present invention includes a smart irrigation system and/or a mechanized irrigation machine having a main machine controller, a plurality of distributed controllers, and a communications network. The distributed controllers may be located at a plurality of spaced apart locations on the mechanized irrigation machine. The communications network may communicably couple the plurality of distributed controllers, the main machine controller, and local or remote cloud storage. Furthermore, the main machine controller and the plurality of distributed controllers may retrieve or store information from the local or remote cloud storage for maintenance, firmware updates, or troubleshooting of the mechanized irrigation machine. The distributed controllers may perform the following functions: individual tower motor control, span joint control, corner arm control, GPS guidance or positioning of one or more actuatable features of the smart irrigation system, and/or valve control of individual sprinklers for variable rate irrigation.

In other embodiments, a smart irrigation system may include fluid-emitting devices, a plurality of actuatable towers, a plurality of spans, one or more motors, a main machine controller, a plurality of distributed controllers, and a communications network. The fluid-emitting devices may be carried by the plurality of actuatable towers, and the plurality of spans may be connected to and extending between at least two of the actuatable towers. The one or more motors may actuate lateral and/or rotational movement of the actuatable towers. The main machine controller may be located on one of the plurality of towers or one of the plurality of spans, while the plurality of distributed controllers may each be located on one of the plurality of actuatable towers. The communications network may communicably couple the plurality of distributed controllers, the main machine controller, and local or remote cloud storage. Furthermore, the main machine controller and the plurality of distributed controllers may retrieve or store information from the local or remote cloud storage for maintenance, firmware updates, or troubleshooting of the one or more motors or at least one of the fluid-emitting devices.

In some embodiments, a method for maintaining, updating, and troubleshooting a smart irrigation system may include steps of the main machine controller retrieving information from a local or remote cloud storage for maintenance, firmware updates, or troubleshooting of the main machine controller or one or more of the plurality of distributed controllers. Furthermore, the method may include the main machine controller sending the information for maintenance to one or more of the plurality of distributed controllers, as well as the main machine controller sending the information for firmware updates to one or more of the plurality of distributed controllers. In some embodiments, the method may also include the main machine controller sending the information for troubleshooting to one or more of the plurality of distributed controllers.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an irrigation system constructed in accordance with an embodiment of the invention;

FIG. 2 is a block diagram of communicably-coupled components of the irrigation system constructed in accordance with an embodiment of the invention;

FIG. 3 is a flow chart depicted a method for maintaining, updating, and troubleshooting the irrigation system of FIG. 1 in accordance with an embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

References to “one embodiment”, “an embodiment”, or “embodiments” herein mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, or method step described in one embodiment may also be included in other embodiments but is not necessarily included. Thus, the current invention can include a variety of combinations of the embodiments described herein.

Basic, discrete communications provided by prior art irrigation systems are not sufficient for the many variables and irrigation needs for which modern irrigation systems are used. Thus, the present invention provides a smart irrigation system having communications networks configured to, among other things, facilitate firmware updates for specific ones of the distributed controllers within the irrigation system. Furthermore, the communications networks described herein advantageously communicate with and log information from the distributed controllers and a main machine controller may use that information for troubleshooting the smart irrigation system and its distributed controllers' operational status and/or performance, as described in more detail herein.

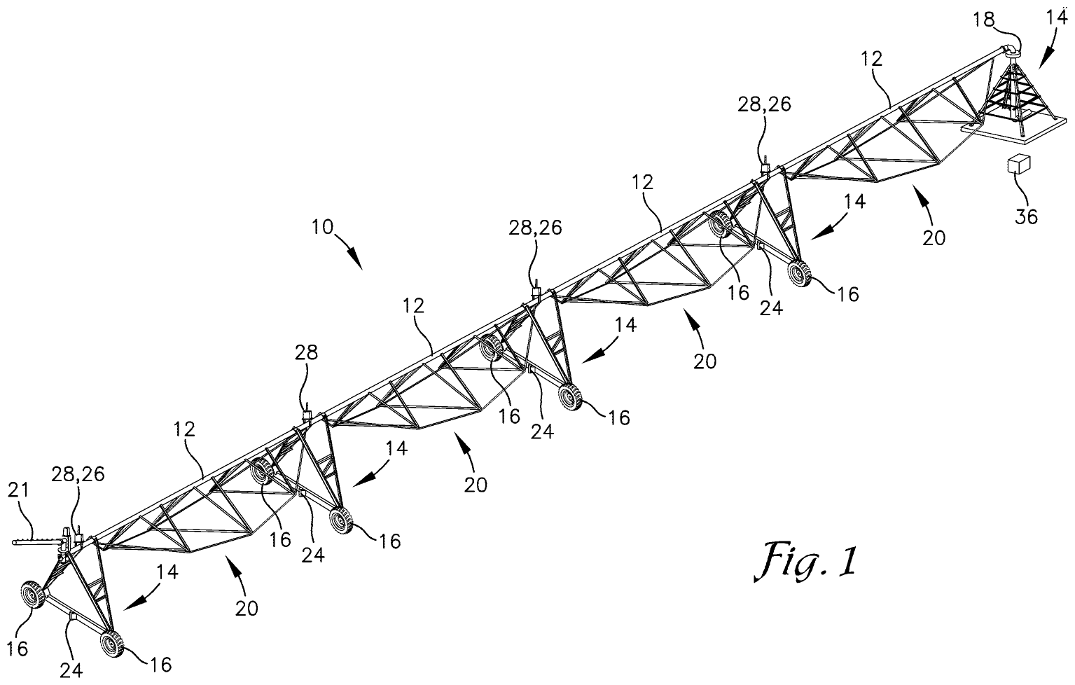

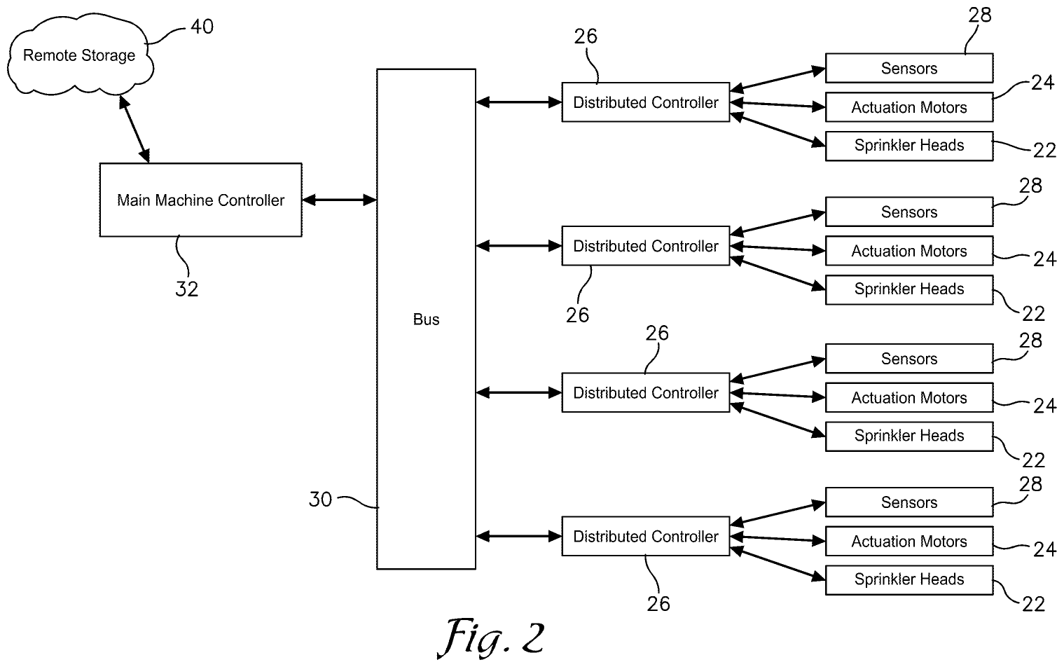

In accordance with one embodiment of the invention, FIG. 1 depicts a smart irrigation system 10 comprising various irrigation system structural components (e.g., spans 12, towers 14 supporting the spans 12, wheels 16 rotatably attached to the towers 14 for travel thereby, pivots or joints 18 via which one or more of the spans 12 and/or towers 14 can pivot or rotate, truss-type framework sections 20 supporting the spans 12 and/or maintaining spacing between the towers, one or more sprinkler heads (e.g., sprinkler heads 22 in FIG. 2) or other fluid openings through which liquid may be dispensed, and/or the like). The smart irrigation system 10, as depicted in FIG. 2, may also include communicably and/or electrically-coupled components such as actuation motors 24, distributed controllers 26, one or more sensors 28, one or more communication components (e.g., a data bus 30), and a main machine controller 32. The main machine controller 32 may comprise and/or be communicably coupled with the one or more distributed controllers 26.

The smart irrigation system 10 may be a mechanized irrigation machine and may include structural components of any agricultural irrigation machine known in the art, such as a central pivot irrigation machine and/or a lateral move irrigation machine, each commonly used to irrigate crops. A central pivot irrigation machine, for example, may include a central pivot communicating with a pressurized water supply and a series of spans (e.g., the spans 12) suspended over the field by mobile support towers (e.g., the towers 14). The spans 12 may be rigid, elongated pipes or frame pieces. In some embodiments, the spans may include pipes and/or hoses through which liquid for irrigating the field is transmitted to the sprinkler heads 22 or other fluid openings. The towers 14 may have an A-frame configuration or any configuration known in the art for suspending the spans over the field. The spans 12 and/or the towers 14 may be connected to the central pivot (e.g., pivot 18). On the other hand, a lateral move irrigation machine may omit the central pivot, with all of the mobile support towers 14 or the wheels 16 thereof configured to be actuated independently (e.g., via actuation motors 24) for lateral travel across a field.

The towers 14 may be supported on the wheels 16 that are driven by a motor (e.g., the actuation motors 24) on each tower 14. However, in some embodiments, the wheels 16 may be replaced with other lateral move mechanisms such as rail along which the towers slide and/or ball bearings, tank-like treads, or the like. For either the central pivot irrigation machine or the lateral move irrigation machine, in addition to the spans 12, the truss-type framework sections 20 may additionally or alternatively extend between the mobile support towers and/or support eh spans.

In some embodiments, the pivots or joints 18 may include one or more pivot mechanisms rotatably or pivotally attaching one of the spans with one or more of the towers or another one of the spans, allowing for independent movement of one or more of the spans. Such joints 18 may be used for irrigation of fields having non-square and/or non-rectangular shapes, allowing one end or both ends of the spans to at least partially pivot to accommodate the shape of the field. Additionally, in some lateral move or central pivot irrigation machines, the spans 12 may further include a corner span 21 that is connected via one of the pivots or joints 18 to an outer end one of the towers 14 and/or an outer end one of the spans 12. The corner span can be used, for example, to extend out into a corner of a field that would not be reached by the irrigation machine otherwise.

Pipes and/or hoses supported on or formed through the spans 12 may be fluidly coupled with a number of the sprinkler heads 22, spray guns (e.g., end guns), drop nozzles, or other fluid-emitting devices may be spaced along the length of the conduit. However, the sprinkler heads 22 may be replaced with other spray heads, valves, or openings (e.g., small openings through the pipes or hoses allowing water or other liquids to seep therethrough) without departing from the scope of the invention.

The actuation motors 24 may be drive motors for driving the wheels 16 clockwise and/or counterclockwise. For example, the actuation motors 24 may each turn at least one of its wheels 16 through a drive shaft to move a corresponding one of the mobile towers 14 and thus the spans 12 attached thereto in a circle about the central pivot and or forward or aftward across a field in order to irrigate the field. The actuation motors 24 may, in some embodiments, be coupled with integral or external relays for turning the actuation motors 24 on, off, and reversed. The actuation motors 24 may also have several speeds or be equipped with variable speed drives. Although not required, some or all of the towers may be equipped with steerable wheels pivoted about upright axes by suitable steering motors so that the towers can follow a predetermined track.

The various controllers may include one or more distributed controllers 26. For example, each of the distributed controllers 26 may be coupled to one or more of the motors and may be configured to send instructions to these motors and/or receive feedback from the motors and/or various sensors described herein. Each of the distributed controllers 26 may comprise any number or combination of processors, controllers, ASICS, computers, or other central circuitry and is provided for receiving instructions from the main machine controller 32 and controlling activation of its motor or motors in response thereto. The distributed controllers 26 may also include variable speed drive circuitry when the motors are variable speed motors.

Other examples of controllers may include: tower motor control/monitor controller at each tower, a corner arm controller at an outer end of the spans, a rotational controller that controls rotation of an outboard portion of the smart irrigation system 10 around an intermediate tower (such as a FIELD PLUS controller), global positioning system (GPS) guidance controller for lateral move irrigation systems, GPS position sensor (or other such sensors providing miscellaneous output for such things as end gun control), and/or variable rate irrigation (VRI) controllers and/or other valve or sprinkler head controllers.

In some embodiments, the corner arm controller may be located on or proximate to an end of the smart irrigation system 10 (e.g., such as on a corner arm and/or an end tower to which the corner arm is pivotally or rotatably attached). The corner arm controller may be configured to manage and/or control real-time kinematic (RTK)-corrected GPS for guidance to swing the corner arm out into corners of the field, for example. The rotational controller may be configured to instruct motors, brakes, and/or other such motion-control components of one of the intermediate towers of the smart irrigation system 10 to stop and the rest of the spans or towers outboard of that intermediate tower to continue rotating about the intermediate tower that stopped. In some embodiments, the GPS guidance controller may be configured for a lateral-move irrigation system and may be, for example, configured to keep each of the lateral spans and their associated towers moving in a straight line. The VRI controller may be configured to control each sprinkler on the smart irrigation system 10 to allow infinite control of water application. Other distributed controllers 26 may be used in the smart irrigation system 10 described herein without departing from the scope of the technology herein.

In some embodiments, the distributed controllers 26 may distribute some of the processing requirements of the main machine controller 32. For example, in some embodiments, the main machine controller 32 may determine a degree of misalignment of each mobile tower and then send instructions to each distributed controller 26 on the amount of correction needed. Each distributed controller 26 may further determine how long to operate its motor or motors, and at which speed, to re-align the corresponding mobile towers. In still other embodiments of the invention, the distributed controllers 26 may comprise one or more external computing devices not located on the smart irrigation system 10. The external computing device may communicate with the drive motors and/or elements of the distributed controllers 26 connected to the drive motors via wireless communication channels.

The one or more sensors 28 may include a location-determining component, a rain sensor, an angle sensor, a speed sensor, and/or any other sensors known in the art of irrigation equipment. These sensors 28 may be communicably coupled with one or more of the distributed controllers 26 and/or with the main machine controller 32. The location-determining component may be any device capable of determining each mobile tower's position or orientation. The location-determining component may comprise, for example, the angle sensor or an angle encoder positioned at the joint of each span of the irrigation system for sensing an angle between each span and the adjacent span or spans. In some embodiments, the angle encoders may be incorporated in existing articulating joints positioned between the spans so that the control system does not require its own dedicated angle encoders.

The location-determining component may also be a global navigation satellite system (GNSS) receiver such as a GPS receiver, Glonass receiver, Galileo receiver, or compass system receiver attached to or near each mobile tower and operable to receive navigational signals from satellites to calculate a position of each of the mobile towers as a function of the signals. Each GNSS receiver may include one or more processors, controllers, or other computing devices and memory for storing information accessed and/or generated by the processors or other computing devices. In some embodiments, a single GNSS receiver receives satellite signals from separate antennas mounted to each mobile tower so that a receiver is not required at each tower. The GNSS receiver or receivers may be incorporated in the main control system so that the control system does not require its own dedicated GNSS receivers or may be stand-alone devices. Each GNSS receiver may be coupled with a patch antenna, helical antenna, or any other type of antenna.

The location-determining component may also comprise one or more modified cam switches, proximity switches, optical encoders, potentiometers, light bar sensors, etc. at each span joint. The location-determining component may additionally or alternatively comprise other type of receiving devices capable of receiving location information from at least three transmitting locations and performing basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

The rain sensor may include any quantity of rain sensors distributed in any manner on structural components of the smart irrigation system 10 and/or distributed in one or more locations throughout a field to be irrigated thereby. The rain sensor or rain sensors may, however, be omitted without departing from the scope of the technology described herein. As noted above, an angle sensor or an angle encoder may be configured for determining alignment between spans. Furthermore, in some embodiments, an angle sensor may determine other relevant angular measurements for control and feedback related to the structural components of the smart irrigation system 10 as they related to the ground and/or to each other. In some embodiments, the sensors may include one or more speed sensors coupled with the wheels and/or the location-determining component for determining speed of one or more structural components or one or more towers of the smart irrigation system 10. However, the speed sensors may include any type of speed sensor or speedometer known in the art without departing from the scope of the technology described herein.

The one or more communication components may include one or more receivers, transmitters, transceivers, data buses, or other wireless or wired communications components known in the art. The communication components may be a component of and/or be communicably coupled with the main machine controller as well as one or more of the distributed controllers 26 and/or sensors for sending and receiving signals and data therebetween.

The main machine controller 32 may be located anywhere on the smart irrigation system 10 (e.g., located at a pivot point on a center pivot irrigation system or at a lateral cart or tower of a lateral-move irrigation system). The main machine controller 32 may comprise processors, memory, circuitry, transmitters, receives, and/or the like, and may further include and/or be communicably coupled with the one or more distributed controllers 26, as well as any of the communication components and sensors described herein. One embodiment of the main machine controller 32 is illustrated in FIG. 2 and comprises a computing device or processor, memory, and one or more ports (e.g., input/output ports, I/O ports, wired or wireless communication ports, and the like). Some or all of the functionality of the main machine controller 32 may be performed by a separate main control system, cloud computing or off-site processors (e.g., remote storage 40), and/or one or more of the distributed controllers 26. Alternatively, the main machine controller 32 may be a single control system that processes and carries out some or all of the functions locally.

The main machine controller 32 and/or its processor may receive inputs from other components such as the distributed controllers 26 and/or the sensors described herein and may control operation of the actuation motors 24 to move and/or align the mobile towers 14. The processor may comprise or include any number or combination of processors, controllers, ASICs, computers or other control circuitry.

A computer program that may be implemented by the processor 34 may perform some of the control functions described herein. The computer program preferably comprises an ordered listing of executable instructions for implementing logical functions in the computing device. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The memory may be any electronic memory that can be accessed by the computing device and operable for storing instructions or data. For example, the memory or other memory may store control programs for operating the motors in particular sequences and related data. The memory may be integral with the processor or may be external memory accessible by the processor. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the computing device or may communicate over a bus or other mechanism that facilitates direct or indirect communication. The memory may optionally be structured with a file system to provide organized access to data existing thereon.

The one or more ports (e.g., input/output ports, I/O ports, wired or wireless communication ports, and the like) may allow operators to input instructions into the main machine controller 32 or otherwise operate or interact with the smart irrigation system 10. In addition to the one or more ports, other inputs to the main machine controller 32 may include any number and type of knobs, buttons, switches, dials, etc. or may be a part of a user interface such as a touchscreen display. The main machine controller 32 may also include a display, inputs for receiving programs and data from external devices, a cellular or other radio transceiver for wirelessly receiving and transmitting data from and to remote devices, and/or other components. The above-described components of the main machine controller 32 need not be physically connected to one another since wireless communication among the various depicted components is permissible and intended to fall within the scope of the present invention.

Some or all of the components of the main machine controller 32 may be enclosed in or supported on a weatherproof housing for protection from moisture, vibration, and impact. The housing may be positioned anywhere on structural components of the smart irrigation system 10 and may be constructed from a suitable vibration- and impact-resistant material such as, for example, plastic, nylon, aluminum, or any combination thereof and may include one or more appropriate gaskets or seals to make it substantially waterproof or resistant.

In use, the smart irrigation system 10 and/or its main machine controller 32 described herein may communicate to the distributed controllers 26 for one or more of the following: settings of the distributed controller 26, command and control of the function or functions each distributed controller 26 is performing, and firmware updates to the distributed controllers. Specifically, the smart irrigation system 10 as described herein be configured to utilize the communication system (e.g., the data bus 30, such as a LAN or WAN) in a manner that allows communication from the main machine controller 32 to any other controllers on the smart irrigation system 10, such as the distributed controllers 26 described above. This communication may occur on the data bus 30 that is either wired or wireless, which may include a local area network (LAN) or a wide area network (WAN) topology. The data bus 30 may be configured to communicate via CAN bus, Modbus, ethernet, ethernet over powerline, or any other data bus style protocol. Additionally, this information may be relayed to/from other controllers (e.g., the distributed controllers 26) to the main machine controller 32 via the cloud or other remote servers/processors (e.g., remote storage 40).

Furthermore, in some embodiments, the main machine controller 32 may be configured to communicate one or more of the following to any of the distributed controllers 26 described above: machine speed, direction of movement, safety status, and/or end gun(s) control. For example, control responses from a corner controller of the smart irrigation system 10 to the main machine controller 32 may include any one or more of the following: safety status of the corner, commanded speed of the variable frequency drives (VFDs), location of a corner swing tower, swing tower angle, heading of movement, status of movement (e.g., determining if the corner stuck), real time kinematic (RTK) GPS lock status, number of GPS satellites in view, and horizontal dilution of precision (HDOP) of GPS. Similarly, control responses from the distributed controllers 26 to the main machine controller 32 may include the same or similar control responses and/or other such sensed data. The main machine controller 32 may also communicate with the distributed controllers 26 (e.g., corner controller, FIELD PLUS controller, GPS guidance controller) informational items from a GPS base to a GPS rover (e.g., RTK lock data, GPS status, GPS base setup information), maintenance items (e.g., commanded frequency of VFDs, VFD status, GPS receiver status, voltage at one or more towers, amp draws of VFD, etc.), and/or updated firmware, as described below.

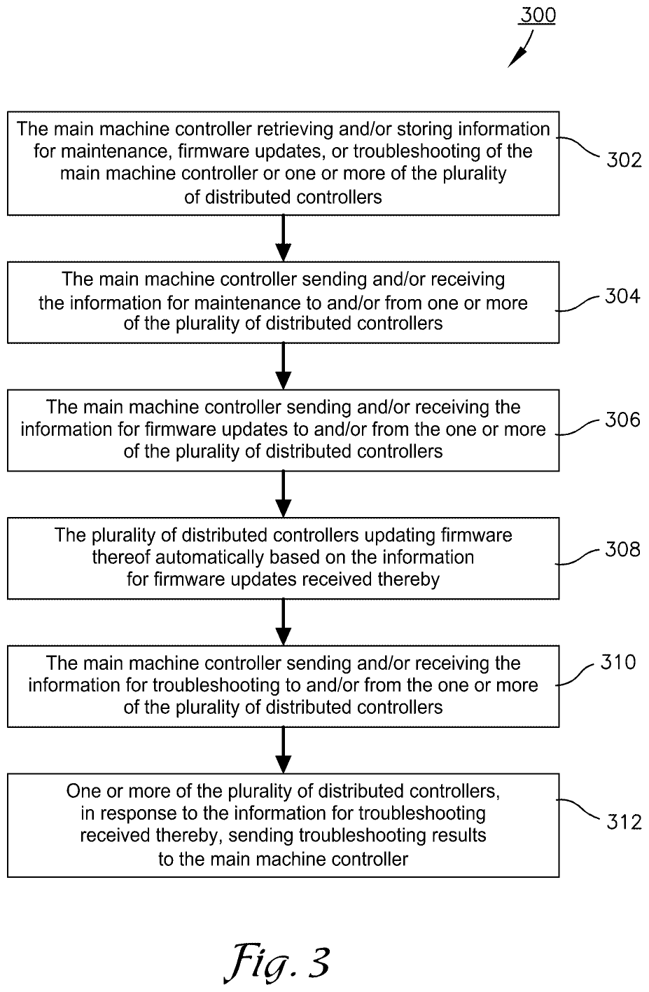

At least a portion of the steps of a method 300 for maintaining, updating, and troubleshooting the smart irrigation system 10 as described herein in accordance with various embodiments of the present invention is listed in FIG. 3. The steps may be performed in the order as shown in FIG. 3, or they may be performed in a different order. Further, some steps may be performed concurrently as opposed to sequentially. In addition, some steps may be omitted. Still further, embodiments of the present invention may be performed using systems other than system 10 without departing from the spirit of the present invention.

In some embodiments, the method 300 may include a step of the main machine controller retrieving, from a local or remote cloud storage (e.g., remote storage 40), and/or storing information for maintenance, firmware updates, or troubleshooting of the main machine controller or one or more of the plurality of distributed controllers, as depicted in block 302. For example, the main machine controller 32 may retrieve or store information from remote cloud storage when initiated in the field, particularly if the main machine controller 32 is replacing an original main machine controller and now requires the setup or configuration information previously used by the original main machine controller and/or required for a particular smart irrigation system or field. Likewise, the main machine controller may receive information for maintenance, firmware updates, or troubleshooting of one or more of the distributed controllers, such as distributed controllers configured for any of the following functions: individual tower motor control of one or more tower motors of the smart irrigation system, span joint control of one or more span joints of the smart irrigation system, corner arm control of at least one corner arm of the smart irrigation system, GPS guidance or positioning of one or more actuatable features of the smart irrigation system, and/or valve control of individual sprinklers (e.g., sprinkler heads 22) of the smart irrigation system 10 for variable rate irrigation.

The method 300 may further include a step of the main machine controller 32 sending and/or receiving the information for maintenance to and/or from one or more of the plurality of distributed controllers, as depicted in block 304. This sort of maintenance communication may occur from the main machine controller 32 to one or more of the distributed controllers 26 (and from the one or more of the distributed controllers 26 to the main machine controller 32) on the smart irrigation system 10. The maintenance communication may include one or more of the following: custom parameters, updated firmware, information items, and logged files/information. The custom parameters, as described herein, may be those parameters set in any of the distributed controllers 26 that deviate from factory default settings. These custom parameters may be set-up during machine configuration in the field, can be stored locally at the distributed controller 26, and/or can be stored either at the main machine controller 32 (e.g., a central controller at an edge/pivot point) or in the cloud (e.g., remote storage 40) to aid in re-configuring the distributed controllers 26 of the smart irrigation system 10 if the main machine controller 32 is ever replaced or otherwise reset.

Once any of the parameters are updated from default settings, the distributed controller 26 may store that updated parameter. The distributed controller 26 may then communicate that stored parameter to the main machine controller 32 for storage therein (e.g., at the edge/pivot point) or in the cloud (e.g., remote storage 40). This storage can occur either automatically or via user command. If one of the distributed controllers 26 is replaced in the field, part of the set-up of the new distributed controller may be to request the stored parameters from its storage location, whether that is at the main machine controller 32, the cloud, or other remote storage. This can streamline the process of replacing one of the distributed controllers 26 in the field.

The method 300 may also include a step of the main machine controller 32 sending and/or receiving the information for firmware updates to and/or from the one or more of the plurality of distributed controllers, as depicted in block 306. For example, updated firmware for the distributed controllers 26 may be relayed from the main machine controller 32 to any of the distributed controllers 26 on its data bus 30. This may be done on a push basis or when requested by a maintenance technician. The updated firmware may be stored either in the main machine controller 32, an external storage device (such as a USB thumb drive), or in the cloud (e.g., remote storage). The firmware updates may be pulled by the distributed controllers or the main machine controller 32 or pushed by a remote central controller via the communications network. The distributed controllers 26. can also provide confirmation signals back to the main machine controller 32 and/or pass such feedback or information on to others of the distributed controllers 26.

In some embodiments, the method 300 may include a step of one or more of the plurality of distributed controllers updating firmware thereof automatically based on the information for firmware updates received thereby, as depicted in block 308. For example, the distributed controller 26 that needs the updated firmware may either request (e.g., pull) or be pushed a copy of the new firmware (e.g., via the LAN or WAN topology) from the stored location and then the distributed controller 26 may update the firmware based on the firmware information received from the main machine controller 32. The update may occur as soon as the distributed controller receives the firmware update information and/or at a particular interval or a predetermined time.

The method 300 may also include a step of the main machine controller 32 sending and/or receiving the information for troubleshooting to and/or from the one or more of the plurality of distributed controllers, as depicted in block 310. In some embodiments, logged files/information from the distributed controllers 26 may be sent to the main machine controller 32 and/or otherwise used for troubleshooting the smart irrigation system 10 and the distributed controllers' operational status or performance. Examples of such informational items may include but are not limited to: historic amp load data, historic voltage levels at the distributed controller, historic operational status (e.g., which may be specific to the individual distributed controller), historic vibrational levels, historic ambient noise levels, historic tilt of one or more components of the smart irrigation system 10, historic tire pressure levels, historic location of one or more components of the smart irrigation machine 10 (e.g., such as at the distributed controller), and/or historic gearbox and motor operational status (e.g., oil levels, temperatures, or the like).

Furthermore, in some embodiments, the method 300 may include a step of one or more of the plurality of distributed controllers, in response to the information for troubleshooting received thereby, sending troubleshooting results or readings to the main machine controller, as depicted in block 312. For example, the troubleshooting results or readings may be associated with one or more of the following smart irrigation system components: one or more motors, one or more sprinkler head valves, and one or more sensors of the smart irrigation system.

In some embodiments, an of the information for maintenance, firmware updates, or troubleshooting may include and/or be based on various other informational items. The informational items from the distributed controllers 26 may be used to indicate to the operator the current status of the distributed controllers 26 and the item it is controlling (e.g., a tower motor or the like). Examples of such informational items may include one or more of the following: amperage being consumed, voltage at the distributed controller, operational status (e.g., which may be specific to the individual distributed controller), current vibrational levels, current ambient noise levels, current tilt of one or more components of the smart irrigation system 10, current tire pressure levels, current location of a sensor associated with the distributed controller, and/or gearbox and motor operational status (e.g., oil levels, temperatures, or the like).

The informational items may be transmitted to the main machine controller 32 and/or to cloud/remote storage. Likewise, this information may be accessed via displays or ports of the main machine controller 32 and/or other remote devices in communication with the main machine controller 32 and/or associated cloud/remote storage associated therewith. In this way, such informational items may assist an operator in troubleshooting to determine what problems exist on the smart irrigation system 10 and/or how to solve them. However, in some embodiments, the main machine controller 32 may be configured and or programmed to use such informational items for automatically detecting and correcting issues based on thresholds, variables, and/or various algorithms.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

What is claimed is:

1. A mechanized irrigation machine, comprising:
a main machine controller;
a plurality of distributed controllers located at a plurality of spaced apart locations on the mechanized irrigation machine;
a communications network communicably coupling the plurality of distributed controllers, the main machine controller, and local or remote cloud storage, wherein the main machine controller and the plurality of distributed controllers are configured to retrieve or store information from the local or remote cloud storage for maintenance, firmware updates, or troubleshooting of the mechanized irrigation machine.

2. The mechanized irrigation machine of claim 1, wherein one or more of the plurality of distributed controllers are configured for controlling one or more of the following functions:
individual tower motor control;
span joint control;
corner arm control;
GPS guidance or positioning of one or more actuatable features of the mechanized irrigation machine; and
valve control of individual sprinklers for variable rate irrigation.

3. The mechanized irrigation machine of claim 1, wherein the communications network is a hardwired Local Area Network (LAN) or a radio connected wide-area network (WAN).

4. The mechanized irrigation machine of claim 1, wherein the maintenance information retrieved via the communications network includes controller configuration information for reconfiguring the main machine controller or one or more of the plurality of distributed controllers.

5. The mechanized irrigation machine of claim 1, wherein the troubleshooting information includes at least one of the following:
current operational status of the main machine controller,
current operational status of one or more of the plurality of distributed controllers,
historical log files of the operational status of the main machine controller, and
historical log files of one or more of the plurality of distributed controllers.

6. The mechanized irrigation machine of claim 1, wherein the firmware updates are either pulled by the distributed controllers or the main machine controller or pushed by a remote central controller via the communications network.

7. The mechanized irrigation machine of claim 1, wherein the communications network is communicably coupled with remote cloud storage via a radio connection or a hard-wired connection.

8. A smart irrigation system comprising:
fluid-emitting devices;
a plurality of actuatable towers, wherein the fluid-emitting devices are carried by the plurality of actuatable towers;
a plurality of spans connected to and extending between at least two of the actuatable towers;
one or more motors configured for actuating at least one of lateral and rotational movement of the actuatable towers;
a main machine controller located on one of the plurality of towers or one of the plurality of spans;
a plurality of distributed controllers each located on one of the plurality of actuatable towers;
a communications network communicably coupling the plurality of distributed controllers, the main machine controller, and local or remote cloud storage, wherein the main machine controller and the plurality of distributed controllers are configured to retrieve or store information from the local or remote cloud storage for maintenance, firmware updates, or troubleshooting of the one or more motors or at least one of the fluid-emitting devices.

9. The smart irrigation system of claim 8, wherein one or more of the plurality of distributed controllers are configured for controlling individual control of the one or more motors.

10. The smart irrigation system of claim 8, further comprising a span joint coupling at least one of the plurality of spans to at least one of the plurality of actuatable towers, wherein one or more of the plurality of distributed controllers are configured for controlling the span joint.

11. The smart irrigation system of claim 8, further comprising a corner arm pivotally connected to an end one of the plurality of towers, wherein one or more of the plurality of distributed controllers are configured for controlling pivoting of the corner arm.

12. The smart irrigation system of claim 8, further comprising a GPS guidance controller, wherein one or more of the plurality of distributed controllers are configured for controlling the GPS guidance controller for guiding and positioning of one or more of the plurality of actuatable towers.

13. The smart irrigation system of claim 8, wherein the fluid-emitting devices comprise individual sprinklers and valves associated with the individual sprinklers, wherein one or more of the plurality of distributed controllers are configured for controlling the valves in a variable manner for variable rate irrigation.

14. The smart irrigation system of claim 8, wherein the communications network is a hardwired Local Area Network (LAN) or a radio connected wide-area network (WAN).

15. The smart irrigation system of claim 8, wherein the maintenance information retrieved via the communications network includes controller configuration information for reconfiguring the main machine controller.

16. The smart irrigation system of claim 8, wherein the troubleshooting information includes at least one of the following:
current operational status of the main machine controller,
current operational status of one or more of the plurality of distributed controllers,
historical log files of the operational status of the main machine controller, and
historical log files of one or more of the plurality of distributed controllers.

17. The smart irrigation system of claim 8, wherein the firmware updates are either pulled by the distributed controllers or the main machine controller or pushed by a remote central controller via the communications network.

18. A method for maintaining, updating, and troubleshooting a smart irrigation system having a main machine controller and a plurality of distributed controllers, the method comprising:
the main machine controller retrieving or storing information from a local or remote cloud storage for maintenance, firmware updates, or troubleshooting of the main machine controller or one or more of the plurality of distributed controllers;
the main machine controller sending the information for maintenance to one or more of the plurality of distributed controllers;
the main machine controller sending the information for firmware updates to one or more of the plurality of distributed controllers; and
the main machine controller sending the information for troubleshooting to one or more of the plurality of distributed controllers.

19. The method of claim 18, further comprising:
one or more of the plurality of distributed controllers updating firmware thereof automatically based on the information for firmware updates received thereby; and
one or more of the plurality of distributed controllers, in response to the information for troubleshooting received thereby, sending troubleshooting results or readings to the main machine controller, wherein the troubleshooting results or readings are associated with one or more of the following smart irrigation system components:
one or more motors,
one or more sprinkler head valves, and
one or more sensors of the smart irrigation system.

20. The method of claim 18, wherein one or more of the plurality of distributed controllers are configured for controlling one or more of the following functions for components of the smart irrigation system:
individual tower motor control of one or more tower motors of the smart irrigation system;
span joint control of one or more span joints of the smart irrigation system;
corner arm control of at least one corner arm of the smart irrigation system;
GPS guidance or positioning of one or more actuatable features of the smart irrigation system; and
valve control of individual sprinklers of the smart irrigation system for variable rate irrigation.
